(19) United States
(12) Patent Application Publication
(10) Pub. No.: US 2014/0116195 A1
(43) Pub. Date: May 1, 2014

(54) BICYCLE STEM WITH A SHOCK ABSORBER

(71) Applicant: TIEN HSIN INDUSTRIES CO., LTD., Taichung City (TW)

(72) Inventor: HUNG-MAO GU, TAICHUNG CITY (TW)

(73) Assignee: TIEN HSIN INDUSTRIES CO., LTD., Taichung City (TW)

(21) Appl. No.: 13/865,387

(22) Filed: Apr. 18, 2013

(30) Foreign Application Priority Data
Oct. 29, 2012 (TW) 101220938

(51) Int. Cl. B62K 21/14

(52) U.S. Cl. CPC B62K 21/14
USPC 74/551.2

(57) ABSTRACT

A bicycle stern with a shock absorber which is mounted between a handlebar and a steering tube includes a stem body, a clamping member and an elastomer. The stem body has a clamping portion formed at one end thereof, and two fork portions formed at another end of the stein body. The clamping member is connected with the clamping portion for clamping the handlebar, and the elastomer is disposed between the two fork portions. Under this arrangement, when a shock is generated from the rough road, the elastomer is compressed by the two fork portions, so that the elastomer is deformed appropriately and absorbs the shock from the road. Therefore, a rider could hold the handlebar comfortably.

### BACKGROUND OF THE INVENTION

1. Field of the Invention

The present invention relates to a bicycle stem, and more particularly to a bicycle stem with a shock absorber.

2. Description of Related Art

A conventional bicycle stem with a shock absorber includes a base and a rotating stern. The base is mounted on a top of a steering tube. The base has a receiving space defined therein. The rotating stem is received in the receiving space of the base. One end of the rotating stem is connected to a handlebar. The rotating stem has a receiving hole defined at another end therethrough. An absorbing member is received into the receiving hole of the rotating stem. The absorbing member includes a rubber and two metal cylinders, wherein the rubber is disposed between the two metal cylinders. A fixing bolt is inserted into the absorbing member. Two ends of the absorbing member are sealed by two compressing pads respectively. Under this arrangement, when a rider rides a bicycle on a rough road, the rotating stem is slightly rotated relative to the fixing bolt and the absorbing member absorbs the shock from the road, so that the rider could hold the handlebar of the bicycle comfortably.

However, the conventional bicycle stern with a shock absorber has disadvantages as following.

1. The structure of the conventional bicycle stem with a shock absorber is complicated, so that assembling and manufacturing the conventional bicycle stem with a shock absorber are time-consuming and costly.

2. The size and the weight of the conventional bicycle stem with a shock absorber are large and heavy, so that the weight of the bicycle cannot be reduced.

The present invention has arisen to mitigate and/or obviate the disadvantages of the conventional.

### SUMMARY OF THE INVENTION

The main objective of the present invention is to provide an improved bicycle stem with a shock absorber.

To achieve the objective, a bicycle stem with a shock absorber mounted between a handlebar and a steering tube includes a stem body, a clamping member and an elastomer. The stem body has a clamping portion defined at one end thereof and two fork portions defined at another end thereof. These two fork portions are protruded from the clamping portion of the stem body, and the clamping member is connected with the clamping portion for clamping the handlebar. The elastomer is disposed between the two fork portions. Furthermore, each fork portion has a through hole formed therethrough and the elastomer has a through opening corresponding to the through holes. The steering tube passes through the through holes and the through opening. Each fork portion further has a gap communicates with each through hole. Each fork portion further has a neck portion protruded from the periphery of each through hole, and the neck portions are opposite to each other and abut against two ends of the elastomer. The elastomer is made of polyurethane, silicone gel, or rubber. Furthermore the elastomer can also be a compression spring. A space is defined between the two fork portions and the clamping portion of the stem body. The elastomer has a flat-shaped extending portion extended therefrom and corresponding to the space. A top plane and a bottom plane of the extending portion are respectively abutted against two corresponding inner planes of the two fork portions so as to fill the space completely.

Further benefits and advantages of the present invention will become apparent after a careful reading of the detailed description with appropriate reference to the accompanying drawings.

### BRIEF DESCRIPTION OF THE DRAWINGS

FIG. 1 is an exploded view of a bicycle stem with a shock absorber of a first embodiment of the present invention;

FIG. 2 is an assembled view of the bicycle stem with a shock absorber of the first embodiment;

FIG. 3 is a cross-sectional view along line 3-3 of FIG. 2;

FIG. 4 is a schematic view for showing the bicycle stem with a shock absorber of the first embodiment is assembled between a steering tube and a handlebar;

FIG. 5 is an exploded view of the bicycle stem with a shock absorber of a second embodiment of the present invention;

FIG. 6 is an assembled view of the bicycle stem with a shock absorber of the second embodiment;

FIG. 7 is a cross-sectional view along line 7-7 of FIG. 6;

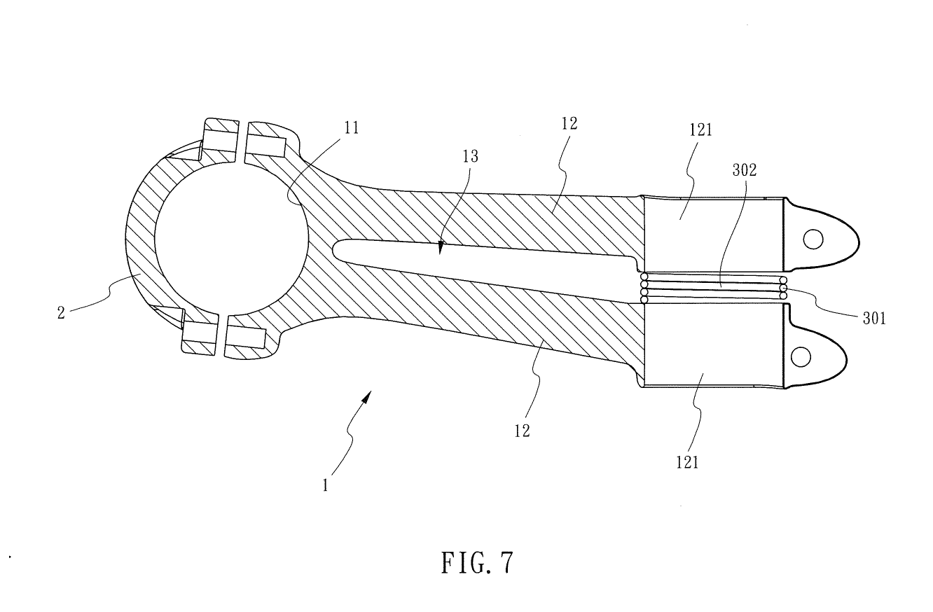

FIG. 8 is an exploded view of the bicycle stem with a shock absorber of a third embodiment of the present invention;

FIG. 9 is an assembled view of the bicycle stem with a shock absorber of the third embodiment;

FIG. 10 is a cross-sectional view along line 10-10 of FIG. 9;

FIG. 11 is an exploded view of a fourth embodiment of the present invention;

FIG. 12 is an assembled view of the fourth embodiment of the present invention; and

FIG. 13 is a cross-sectional view along line 13-13 of FIG. 12.

### DETAILED DESCRIPTION OF THE INVENTION

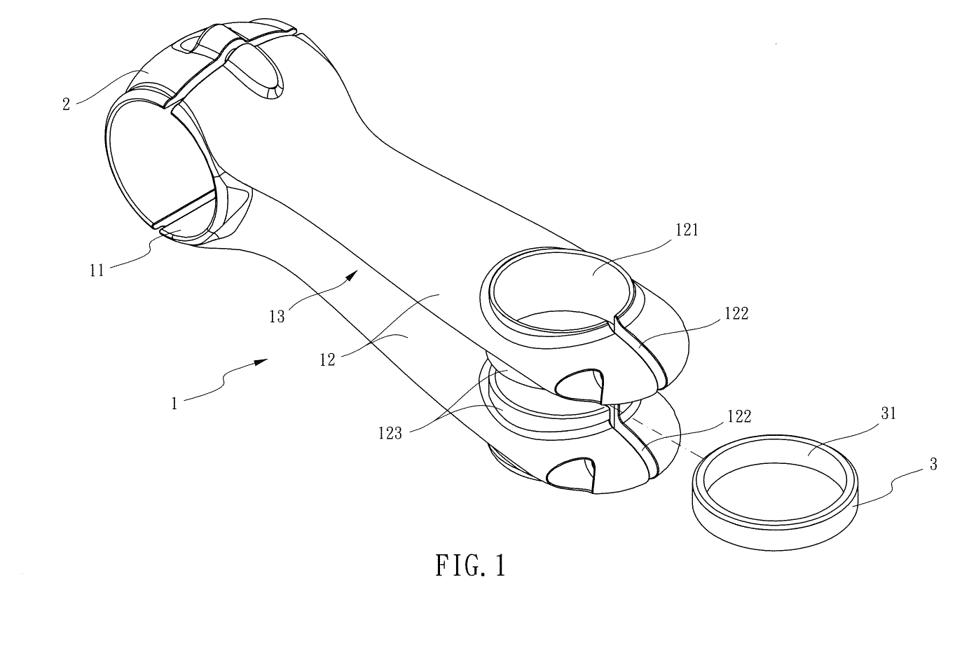

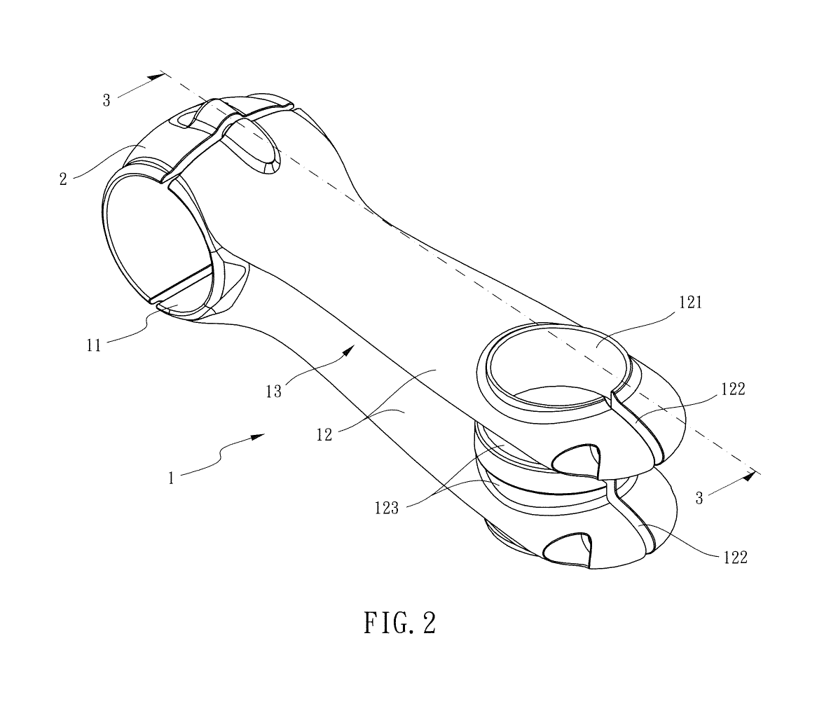

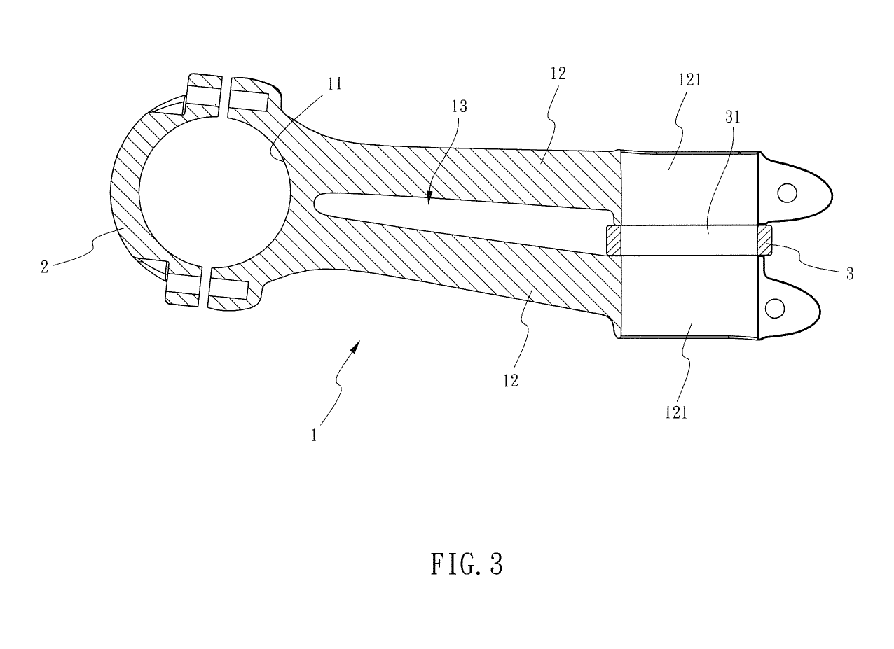

FIGS. 1-4 show a first embodiment of a bicycle stem with a shock absorber in accordance with the present invention. The bicycle stem with a shock absorber is mounted between a handlebar 41 and a steering tube 42.

The bicycle stem with a shock absorber includes a stem body 1 and two fork portions 12. The stein body 1 has a clamping portion 11 defined at one end thereof. The two fork portions 12 are defined at another end of the stem body 1. The clamping portion 11 is arc-shaped. The two fork portions 12 are protruded from the clamping portion 11 of the stern body 1 and a distance is defined between the two fork portions 12. The two fork portions 12 are flat shaped. Each fork portion 12 has a through hole 121 formed therethrough. The steering tube 42 passes through the through holes 121 of the two fork portions 12.

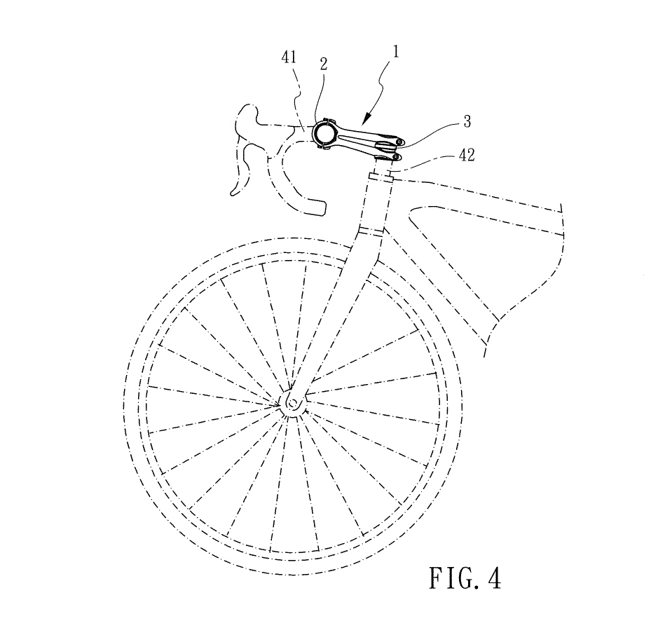

A clamping member 2 is secured to the clamping portion 11 and is connected to the handlebar 41. The clamping member 2 is arc-shaped and corresponds to the clamping portion 11, so that the handlebar 41 is fixed on the clamping portion 11 via the clamping member 2 as shown in FIG. 4. The clamping member 2 is secured to the clamping portion 11 by fasteners.

An elastomer 3 is disposed between the two fork portions 12. The elastomer 3 has a through opening 31 corresponding to the through holes 121 of the two fork portions 12. The steering tube 42 passes through the through opening 31. Two ends of the elastomer 3 are abutted against two peripheries of the two through holes 121 of the two fork portions 12 respectively. Wherein, the elastomer 3 is made of polyurethane, silicone gel, rubber or other materials.

Under this arrangement, the bicycle stem with a shock absorber of present invention is assembled between the handlebar 41 and the steering tube 42. Wherein, the two fork portions 12 are mounted on the steering tube 42 and the elastomer 3 is disposed between the two fork portions 12. When a shock is generated from the rough road, the elastomer 3 is compressed by the two fork portions 12, and the elastomer 3 is deformed appropriately to absorb the shock which is transmitted from a tire via a front fork to the stem body 1. After the shock is absorbed by the elastomer 3, the elastomer 3 is elastically recovered to an original state. Therefore, the elastomer 3 absorbs the shocks from the road, so that a rider holds the handlebar 41 comfortably.

Furthermore, each fork portion 12 further has a gap 122 formed at the same end of the through hole 121 and formed on the circumference of each through hole 121. The gaps 122 and the through holes 121 are shrunk by fasteners, so that the stem body 1 is fastened on the steering tube 42. In contrast, when the fasteners are unsecured, the through holes 121 are enlarged so the stem body 1 is movable on the steering tube 42, and the elastomer 3 could be substituted by another elastomer 3. Therefore, when the elastomer 3 is elastic fatigue or damaged, the rider can replace the elastomer 3 easily by adjusting the fasteners of the stem body 1.

Each fork portion 12 further has a neck portion 123 protruded from the periphery of each through hole 121. The neck portions 123 are opposite to each other and abut against the two ends of the elastomer 3.

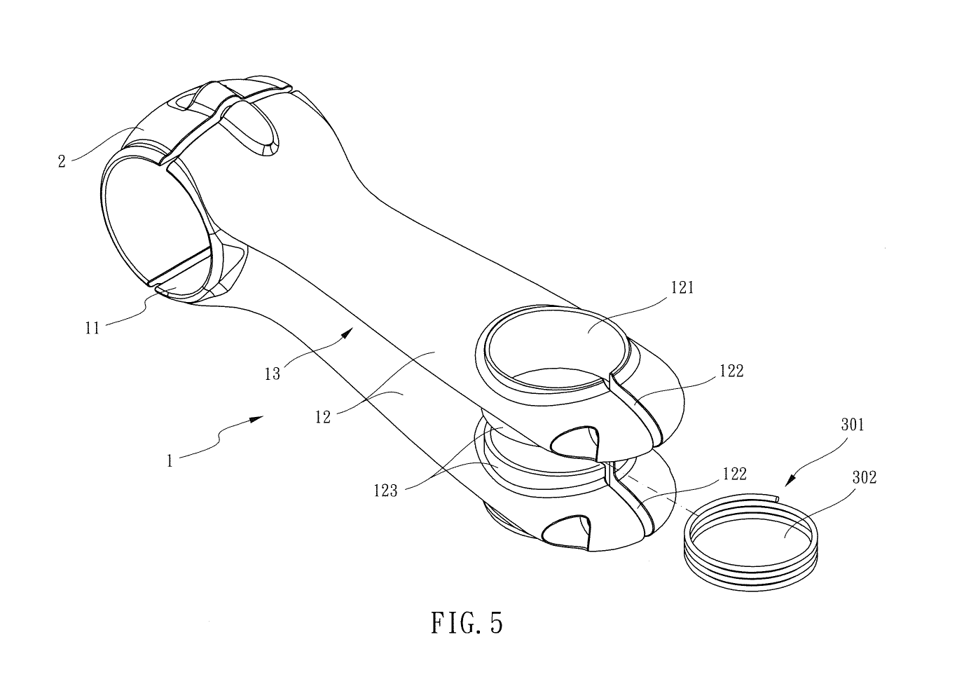

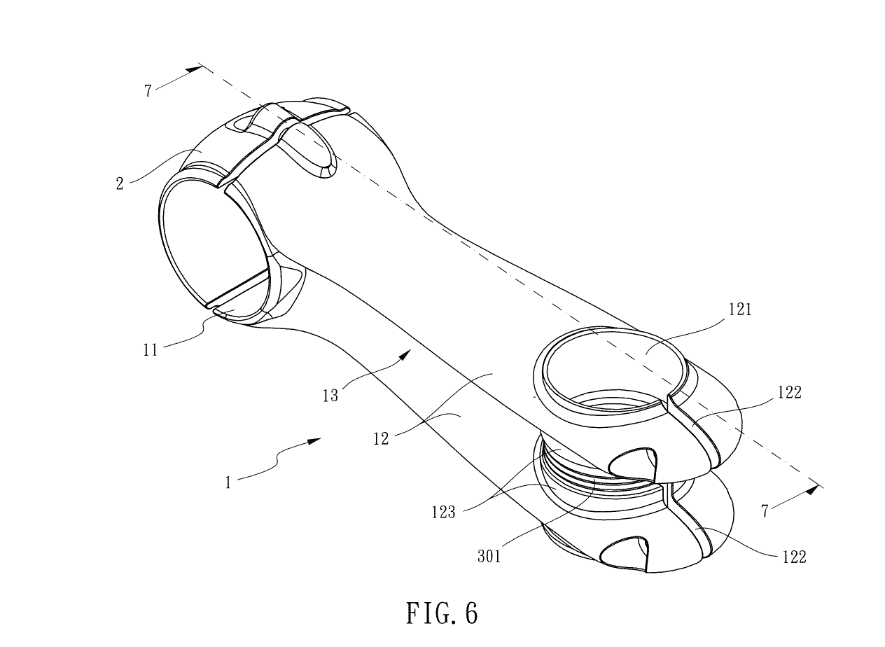

FIGS. 5-6 show a second embodiment of the bicycle stem with a shock absorber in accordance with the present invention (Only the differences between the first embodiment and the second embodiment are further described.). An elastomer 301 is a compression spring. Two ends of the elastomer 301 are abutted against the neck portions 123 of the fork portion 12. The elastomer 301 has a through opening 302 corresponding to the through holes 121 of the fork portion 12. When a shock is generated from the rough road, the elastomer 301 is compressed by the two fork portions 12, and the elastomer 301 is deformed appropriately to absorb the shock, after the shock is absorbed by the elastomer 301, the elastomer 301 is elastically recovered to an original state. Therefore, the elastomer 301 absorbs the shocks from the road, so that the rider holds the handlebar 41 comfortably.

Both in the first embodiment and the second embodiment of present invention, a space 13 is defined between the two fork portions 12 and the clamping portion 11 of the stem body 1. In each embodiment, the elastomer 3, 301 is clipped between the two fork portions 12, so that the space 13 is defined between the elastomer 3, 301 and the clamping portion 11.

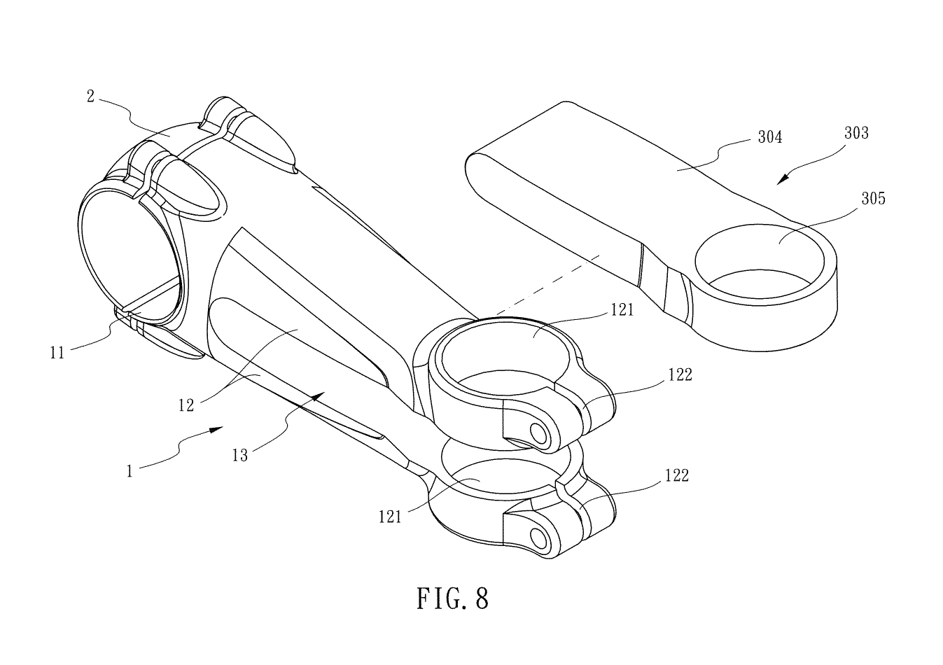

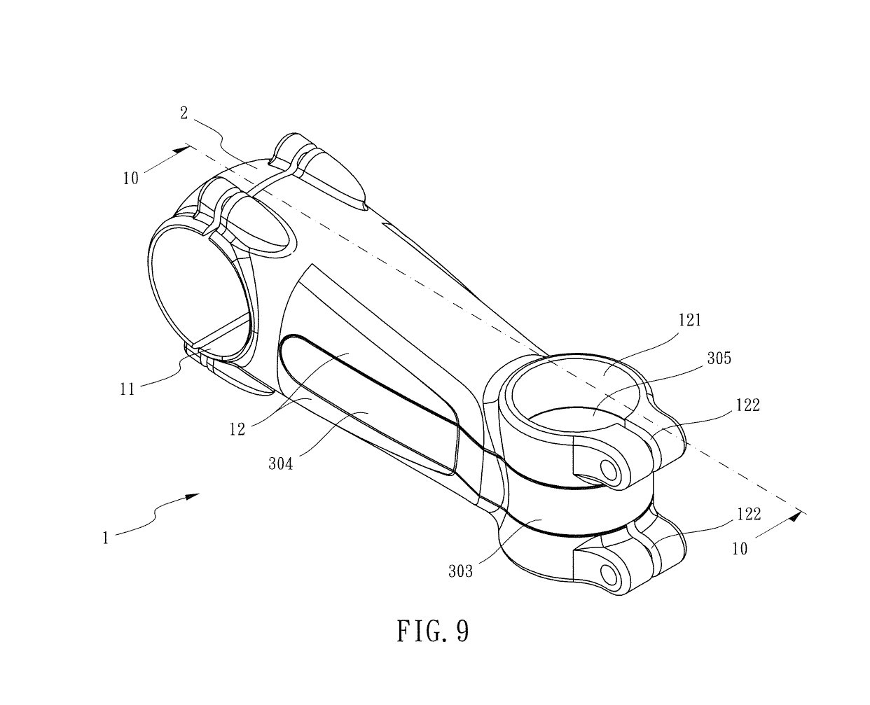

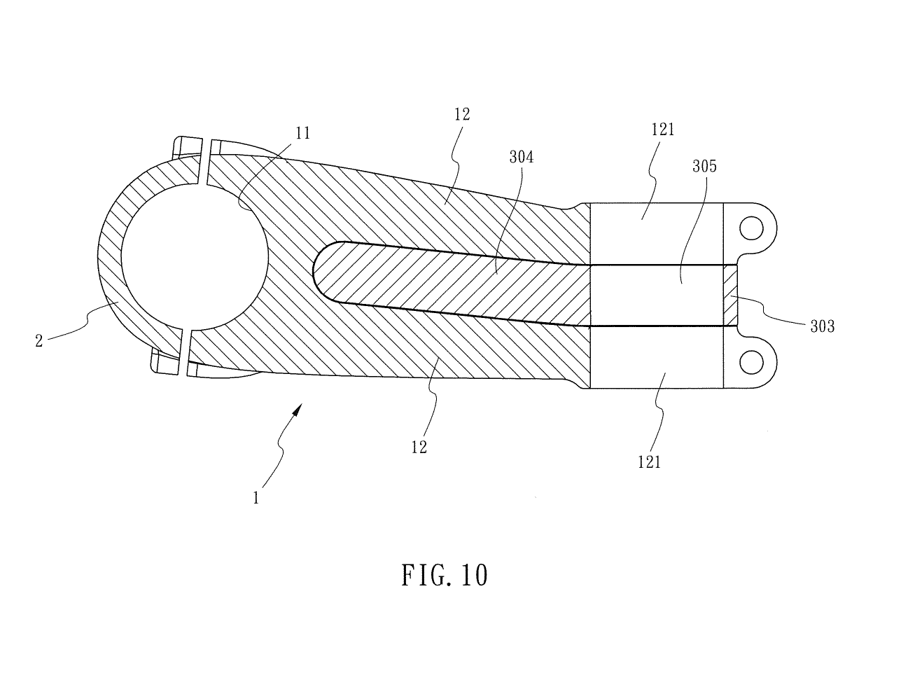

FIGS. 8-10 show a third embodiment of the bicycle stem with a shock absorber in accordance with the present invention (Only the differences between the first embodiment and the third embodiment are further described.). An elastomer 303 is made of polyurethane, silicone gel, rubber or other materials. The elastomer 303 is mounted between the two fork portions 12. The elastomer 303 has an extending portion 304 extended therefrom and corresponding to the space 13. The extending portion 304 is flat-shaped so as to fill the space 13 completely. The elastomer 303 has a through opening 305 corresponding to the through holes 121 of the two fork portions 12, and the top plane and the bottom plane of the extending portion 304 are abutted against two corresponding inner planes of the fork portion 12 respectively. When a shock is generated from the rough road, the elastomer 303 and the extending portion 304 are compressed by the two fork portions 12, so that the elastomer 303 and the extending portion 304 are deformed appropriately and absorbs the shock, in contrast, after the shock is absorbed by the elastomer 303 and the extending portion 304, the elastomer 303 and the extending portion 304 are elastically recovered to an original state. Therefore, the elastomer 303 and the extending portion 304 absorb the shock from the road, so that the rider holds the handlebar 41 comfortably.

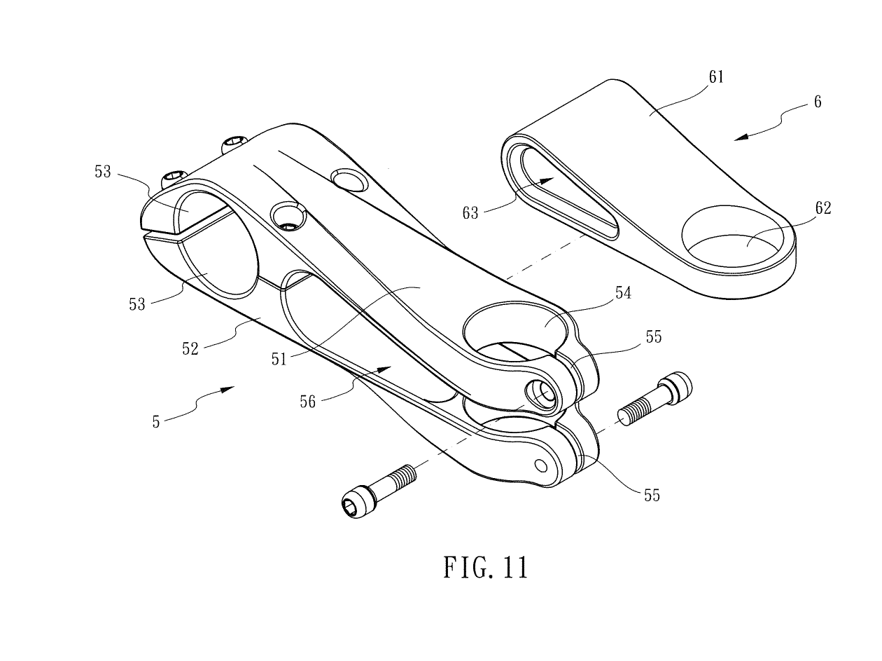

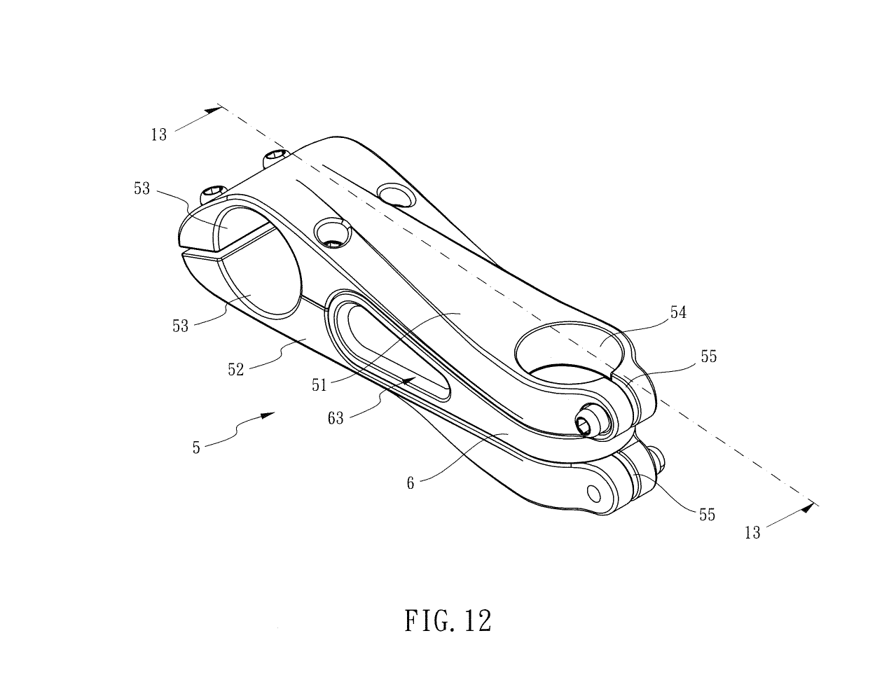

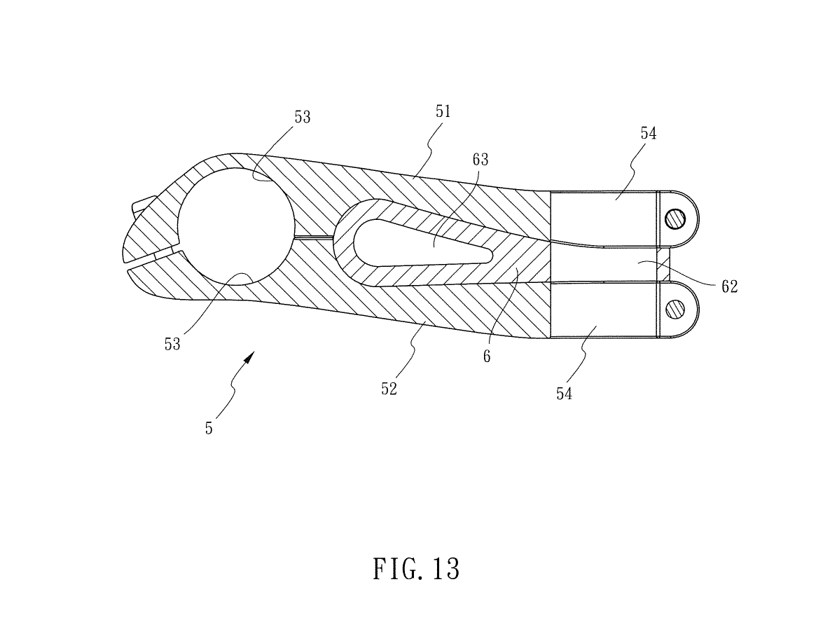

FIGS. 11-13 show a fourth embodiment of the bicycle stem with a shock absorber in accordance with the present invention. The bicycle stem with a shock absorber includes a stem body 5. The stem body 5 has a first fork member 51 and a second fork member 52. The first fork member 51 has one clamping portion 53 defined at one end thereof. The second fork member 52 has another clamping portion 53 defined at one end thereof, and these two clamping portions 53 are arc-shaped. The first fork member 51 has one through hole 54 formed at another end thereof. The second fork member 52 has another through hole 54 formed at another end thereof. The steering tube 42 passes through the two through holes 54 of the first fork member 51 and the second fork member 52. The first fork member 51 and the second fork member 52 are connected with each other and a space 56 is defined between the first fork member 51 and the second fork member 52. A handlebar 41 is clamped by the two clamping portions 53 of the first fork member 51 and the second fork member 52, so that the handlebar 41 is fixed to the stem body 5. The first fork member 51 and the second fork member 52 are secured to each other by fasteners.

An elastomer 6 is disposed between the first fork member 51 and the second fork member 52. The elastomer 6 has an extending portion 61 smoothly extending therefrom, and is corresponding to the space 56. A top side and a bottom side of the extending portion 61 are respectively abutted against an inner side of the first fork member 51 and an inner side of the second fork member 52, so as to fill the space 56 completely. The extending portion 61 of the elastomer 6 further has a hollow portion 63 opened therethrough. Wherein, the elastomer 6 is made of polyurethane, silicone gel, rubber or other materials.

The elastomer 6 has a through opening 62 corresponding to the two through holes 54 of the first fork member 51 and the second fork member 52. The steering tube 42 passes through the two through holes 54 and the through opening 62. When a shock is generated from the rough road, the elastomer 6 is compressed by the first fork member 51 and the second fork member 52. Then, the elastomer 6 is deformed appropriately so as to absorb the shock. Finally, the elastomer 6 is elastically recovered from said deforming state. Therefore, the elastomer 6 absorbs the shock from the road, so that the rider holds the handlebar 41 comfortably.

Furthermore, the first fork member 51 has one gap 55 formed at one end thereof. The second fork member 52 has another gap 55 formed at one end thereof Each gap 55 formed on the circumference of each corresponding through hole 54. The two gaps 55 and the two through holes 54 are shrunk by fasteners which are secured into the stem body 5, so that the stem body 5 is fastened on the steering tube 42. In contrast, when the fasteners are unsecured, the two through holes 54 are enlarged and the stem body 5 is detachable from the steering tube 42. Therefore, when the elastomer 6 is elastic fatigue or damaged, the rider replaces the elastomer 6 easily by adjusting the fasteners of the stem body 5.

Although the invention has been explained in relation to its preferred embodiment, it is to be understood that many other possible modifications and variations can be made without departing from the spirit and scope of the invention as hereinafter claimed.

What is claimed is:

1. A bicycle stem with a shock absorber mounted between a handlebar and a steering tube, comprising:
a stem body having a clamping portion and two spaced fork portions extending from the clamping portion;
at least a clamping member connected with the clamping portion for clamping the handlebar; and
an elastomer disposed between the two fork portions.

2. The bicycle stem with a shock absorber as claimed in claim 1, wherein each fork portion has a through hole formed therethrough, the elastomer has a through opening corresponding to the through holes, the steering tube passes through the through holes and the through opening.

3. The bicycle stein with a shock absorber as claimed in claim 2, wherein each fork portion further has a gap formed at one end thereof, each gap communicates with each through hole.

4. The bicycle stem with a shock absorber as claimed in claim 2, wherein each fork portion further has a neck portion protruding from the periphery of each through hole, the neck portions are opposite to each other and abut against the elastomer.

5. The bicycle stem with a shock absorber as claimed in claim 1, wherein the elastomer is made of polyurethane, silicone gel, or rubber.

6. The bicycle stem with a shock absorber as claimed in claim 1, wherein the elastomer is a compression spring.

7. The bicycle stem with a shock absorber as claimed in claim 2, wherein the elastomer has an extending portion extending between the two fork portions, the top side and the bottom side of the extending portion respectively abut against the two fork portions.

8. The bicycle stem with a shock absorber as claimed in claim 7, wherein the elastomer is made of polyurethane, silicone gel or rubber.

9. A bicycle stem with a shock absorber mounted between a handlebar and a steering tube, comprising:
a stem body having a first fork member and a second fork member;
the fist fork member having a clamping portion defined at one end thereof, the second fork member having another clamping portion defined at one end thereof, the first fork member and the second fork member being connected to each other for clamping the handlebar; and
an elastomer disposed between the first fork member and the second fork member.

10. The bicycle stem with a shock absorber as claimed in claim 9, wherein the first fork member has one through hole formed therethrough, the second fork member has another through hole formed therethrough, the elastomer has a through opening corresponding to the two through holes, the steering tube passes through the two through holes and the through opening.

11. The bicycle stem with a shock absorber as claimed in claim 10, wherein the first fork member has one gap formed at one end thereof, the second fork member has another gap formed at one end thereof, each gap communicates with each corresponding through hole.

12. The bicycle stem with a shock absorber as claimed in claim 10, wherein the elastomer has an extending portion extending therefrom, the extending portion abutted against the first fork member and of the second fork member.

13. The bicycle stem with a shock absorber as claimed in claim 12, wherein the extending portion of the elastomer has a hollow portion opened therethrough.

14. The bicycle stem with a shock absorber as claimed in claim 9, wherein the elastomer is made of polyurethane, silicone gel or rubber.
